(19) United States
(12) Patent Application Publication
(10) Pub. No.: US 2026/0228036 A1
(43) Pub. Date: Aug. 6, 2026

(54) METHOD FOR EXECUTING DATA PROCESSING TASKS

(71) Applicant: Robert Bosch GmbH, Stuttgart (DE)

(72) Inventors: Alexander Artemenko, Ehningen (DE); Eugen Volk, Remseck (DE); Ivan Marinov, Sofia (BG); Sven Erik Jeroschewski, Berlin (DE); Vimalanandan Selva Vinayagam, Schaumburg, IL (US)

(21) Appl. No.: 18/855,848

(22) PCT Filed: May 22, 2023
(86) PCT No.: PCT/EP2023/063556

§ 371 Date: Oct. 10, 2024

(30) Foreign Application Priority Data
Jun. 8, 2022 (DE) 10 2022 205 834.8

(51) Int. Cl. G06F 9/48

(52) U.S. Cl. CPC G06F 9/4856

(57) ABSTRACT

A method for executing data processing tasks using a data processing system. The method includes: executing a data processing task using a first group of data processing devices of the data processing system, wherein the first group contains at least one data processing device, monitoring, when executing the data processing task, a value of a target metric for the execution of the data processing task and, if the value of the target metric leaves a first range assigned to the target metric, outsourcing the execution of at least one subtask of the data processing task to a second group of data processing devices and, if the value of the target metric after the outsourcing operation enters a second range assigned to the target metric, reversing the outsourcing operation of the execution of the at least one subtask.

### FIELD

The present invention relates to methods for executing data processing tasks and to data processing systems.

### BACKGROUND INFORMATION

Since data processing tasks are often too complex for individual, locally provisioned data processing devices, e.g., for controlling a robot, data processing tasks can be distributed to multiple data processing devices, in particular moved from a local data processing device (e.g., in a factory) to an edge cloud or a cloud. However, data processing tasks such as robot control have requirements that must be fulfilled. For example, a robot must carry out a certain task within a certain time in order not to delay a production line or cause errors in the production. Since such requirements may change or the performance capability of the data processing devices and their interconnections may fluctuate, approaches are desirable that make it possible to deal with such changes efficiently.

### SUMMARY

According to various example embodiments of the present invention, a method for executing data processing tasks by means of a data processing system is provided, comprising executing a data processing task by means of a first group of data processing devices of the data processing system, wherein the first group contains at least one data processing device of the data processing system, monitoring, when executing the data processing task, a value of a target metric for the execution of the data processing task and, if the value of the target metric leaves a first range assigned to the target metric, outsourcing the execution of at least one subtask of the data processing task to a second group of data processing devices and, if the value of the target metric after the outsourcing operation enters a second range assigned to the target metric, reversing the outsourcing operation of the execution of the at least one subtask, wherein, if a rate of outsourcing operations and the reversal thereof violates a specified permissibility criterion, the first range assigned to the target metric is increased and/or the second range assigned to the target metric is decreased.

The method according to the present invention described above makes it possible to prevent or at least mitigate jittery behavior with regard to the distribution of data processing (sub) tasks to data processing devices (in particular ping-pong behavior) in scenarios with dynamic resource utilization. It is in particular of high importance if consistent system behavior is expected.

For example, the first range assigned to the target metric is increased and/or the second range assigned to the target metric is decreased until the rate no longer violates the specified permissibility criterion. For example, the rate is monitored or ascertained periodically. Which of the two ranges is changed (and to what extent) can be decided taking into account requirements for the execution of the data processing task. For example, if the first range represents a permissible processing speed, it must not be increased arbitrarily.

Reversing the outsourcing operation does not necessarily have to mean that the data processing task is subsequently executed by exactly the same data processing devices as before the outsourcing operation, but that it is again executed exclusively by data processing devices of the first group after the reversal (not necessarily by all of them and not necessarily by the same ones as before the outsourcing operation).

The first group of data processing devices are, for example, local data processing devices and the second group of data processing devices are, for example, data processing devices of an edge cloud or cloud. For example, the data processing task is the control of a robotic device. In such a case, the first group comprises, for example, one or more data processing devices provided at (e.g., in the same building or in the same local network) or in the robotic device, and the second group comprises one or more remote data processing devices (outside the building, the local network or the robotic device).

Various exemplary embodiments of the present invention are specified below.

Exemplary embodiment 1 is a method for executing a data processing task, as described above.

Exemplary embodiment 2 is the method according to exemplary embodiment 1, wherein the permissibility criterion depends on a number of data processing devices of the first group and/or the second group that execute the data processing task.

In other words, the permissibility criterion depends on the number of data processing devices involved in the redistribution. For example, a rate may be permissible if few data processing devices are involved in the redistribution, since the redistribution then has a lesser effect on the data processing system (i.e., generates less overhead). Ping-pong behavior (with a particular ping-pong pattern) may also be acceptable if the data processing task involves devices that have a high mobility, since switching between data processing devices then, for example, has to take place in order to follow the devices (i.e., in order to provision data processing devices locally at the devices).

Exemplary embodiment 3 is the method according to exemplary embodiment 1 or 2, wherein a benefit of the outsourcing operations is ascertained and the permissibility criterion is specified depending on an ascertained benefit of the outsourcing operations.

In other words, ping-pong behavior may be acceptable if the frequent outsourcing operations it includes have a great benefit, e.g., significantly increase the value of a target metric (e.g., by a certain percentage). For example, a rule may be provided that weighs the benefits of the outsourcing operations against the rate (e.g., by respective weights in a formula) in order to decide whether the rate is acceptable.

Exemplary embodiment 4 is the method according to one of exemplary embodiments 1 to 3, wherein, if the data processing task is executed by means of the first group of data processing devices, the data processing task is distributed according to a first division into subtasks to data processing devices of the first group, and, if the data processing task is outsourced, the data processing task is distributed according to a second division into subtasks to data processing devices of the first and the second group.

The division of the data processing task can thus be changed, which increases the flexibility of the outsourcing operation, in particular the selection of the second group of data processing devices.

Exemplary embodiment 5 is the method according to one of exemplary embodiments 1 to 4, wherein, if the rate of outsourcing operations and the reversal thereof fulfills the specified permissibility criterion and a relaxation criterion, the first range assigned to the target metric is decreased and/or the second range assigned to the target metric is increased.

In other words, a higher rate of outsourcing operations and the reversal thereof can be allowed again if the rate fulfills not only the permissibility criterion but even a (weaker) relaxation criterion. This makes it possible to achieve and benefit from outsourcing operations, for example if more frequent outsourcing operations are currently acceptable in the data processing system. Like the permissibility criterion, the relaxation criterion can be specified depending on various factors (such as benefit and number of data processing devices involved).

Exemplary embodiment 6 is the method according to one of exemplary embodiments 1 to 5, wherein the data processing task is the processing of sensor data to form control commands for a robotic device.

Especially in such a context, the approach described makes it possible to distribute and in particular outsource processing tasks, here for control, to different data processing devices and thus makes reliable control possible, even if, for example, only few resources are available locally.

Exemplary embodiment 7 is a control device configured to monitor and increase the first range assigned to the target metric and/or to decrease the second range assigned to the target metric, according to the method according to one of exemplary embodiments 1 to 6, and to request the data processing system to execute the data processing task according to the first range assigned to the target metric and according to the second range assigned to the target metric.

Exemplary embodiment 8 is a data processing system configured to perform a method according to one of exemplary embodiments 1 to 6.

Exemplary embodiment 9 is a computer program comprising commands that, when executed by a processor, cause the processor to perform a method according to one of exemplary embodiments 1 to 6.

Exemplary embodiment 10 is a computer-readable medium storing commands that, when executed by a processor, cause the processor to perform a method according to one of exemplary embodiments 1 to 6.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a data processing system, according to an example embodiment of the present invention.

FIG. 2 illustrates a mechanism for detecting and mitigating jittery task distribution behavior, according to an example embodiment of the present invention.

FIG. 3 shows a flowchart representing a method for executing data processing tasks by means of a data processing system according to an example embodiment f the present invention.

### DETAILED DESCRIPTION OF EXAMPLE EMBODIMENTS

The following detailed description relates to the accompanying drawings, which show, by way of explanation, specific details and aspects of this disclosure in which the present invention can be executed. Other aspects may be used and structural, logical, and electrical changes may be performed without departing from the scope of the present invention. The various aspects of this disclosure are not necessarily mutually exclusive, since some aspects of this disclosure may be combined with one or more other aspects of this disclosure to form new aspects of the present invention.

Various examples are described in more detail below.

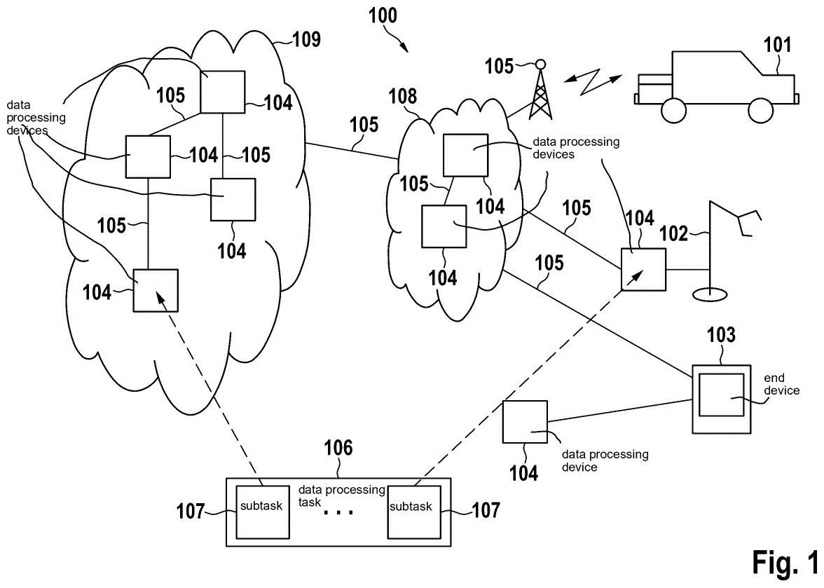

FIG. 1 shows a data processing system 100.

By means of the data processing system 100, various data processing tasks can be executed, for example the control of a robotic device such as a (e.g., autonomous) vehicle 101 or a robotic arm 102 but also a computational task, the result of which is output on an end device 103 (e.g., a personal computer or a smartphone).

For the execution of the data processing tasks, the data processing system has a plurality of data processing devices 104, which provision data processing resources (in particular processors, hardware logic circuits, etc.), and data transmission devices 105, such as transmitters/receivers, and, if necessary, lines of wireless and wired networks (e.g., base stations of mobile radio networks, access points or network cards for wireless or wired local networks, (computer) buses, memories, etc.), which provision data transmission resources (e.g., communication channels). The data processing devices 104 may include data processing devices that are arranged locally at a device to be controlled (e.g., in a control device of a robot), in the controlling device itself (e.g., in a vehicle, e.g., an ECU (electronic control unit) ), in an edge cloud (in the sense of edge computing) 108, or in a cloud 109. The data processing system 100 can thus be regarded as a distributed data processing system.

The data processing system 100 is, for example, a cyber-physical system (CPS) and includes, for example, networking of machines and processes in industry with the help of information and communication technology in the sense of Industry 4.0(I4.0 ), i.e., for example, the control of I4.0 production processes, the control of vehicles, and/or combines networking (e.g., in the sense of the Internet of Things) with artificial intelligence (e.g., one or more data processing devices may implement a machine learning model).

Currently, the complexity of CPS data processing devices used in I4.0 production processes, in the automotive industry or in AIoT is increasing exponentially. In addition, the data processing systems that use such data processing devices (the environments in which such products are used) are continuously changing (e.g., evolving), wherein, instead of cloud-based CPS data processing devices, dynamically distributed CPS data processing devices are also increasingly used, in which time-critical and safety-critical portions of the functionality of a complex data processing task (i.e., application of the data processing system) can be relocated via the device-edge-cloud stack, i.e., the implementation of the functionality can be provisioned by data processing devices in a local device, by an edge cloud or by a cloud.

According to various embodiments, it is accordingly provided that a data processing task 106 is divided into subtasks (or partial tasks) 107. The subtasks 107 implement (at least partially) interacting functional units (i.e., components of the data processing task 106). The subtasks 107 are distributed to the data processing devices 104 for their execution depending on the type and requirements of each subtask. It is also provided that the performance capability of the resources, which are provided by the data processing devices, and the data transmission performance between the data processing devices are monitored and, if necessary, a redeployment (i.e., a redistribution and, optionally, even a redivision into subtasks 107) is executed, for example because the performance capability of the resources, which are provided by the data processing devices, and/or the data transmission performance have decreased and the fulfillment of at least one requirement for the execution of the at least one data processing task is therefore impaired or endangered, or also because it is determined that a different division better fulfills an optimality criterion (e.g., because the computing power has been increased in a cloud and outsourcing is now worthwhile).

A redivision can in particular be an outsourcing operation of a subtask 107 from a local data processing device (e.g., in a factory, where a robotic device 102 to be controlled by means of the subtask 107 is also located) to a remote data processing device (e.g., in the edge cloud 108 or cloud 109) (i.e., offloading).

A corresponding offloading process comprises finding one or more suitable compute nodes (provisioned by one or more data processing devices) that have sufficient resources to process the application 107, and transferring the required computations to this compute node (i.e., the corresponding data processing device). As soon as an application is outsourced from a data processing device to such a compute node, the load on this data processing device (e.g., a client device) decreases and the load on the compute node increases, i.e., the state of the data processing system changes. If multiple applications are outsourced to the compute node, this can therefore, in turn, lead to the outsourcing operation being canceled (e.g., because the resources of the compute node are no longer sufficient) or the application and, if necessary, further applications that run on the same compute node, being outsourced to another compute node. In particular, the case may occur that, after an outsourcing operation, a recovery process is executed after a more or less short period of time, i.e., a reversal of the offloading process, in which one or more subtasks 107 are relocated from a remote data processing device (e.g., in the edge cloud or cloud) back to a local data processing device.

Such offloading and such a recovery (offloading-recovery) can repeat at short intervals (and in principle endlessly) if the measured values and the threshold values of target metrics that affect the offloading decision or recovery decision are very close to one another. This may result in ping-pong behavior (or generally “jittery” behavior, in which redistribution takes place at rapid intervals), which wastes the resources and may lead to instability of the data processing system 100, which at least partially nullifies the benefits of the outsourcing operation.

According to various embodiments, a mechanism is provided that makes it possible to prevent (or at least mitigate) such jittery behavior, taking into account the properties and requirements of the particular data processing task 106 or subtask 107 and also taking into account the effort (and/or costs) for outsourcing. It is provided that jittery behavior (i.e., a redistribution of subtasks 107 (if necessary, including a redivision of the application 106 into the subtasks 107) ) is detected, for example by monitoring how often an outsourcing operation and recovery (or in general a redistribution) occurs. The jittery behavior is then prevented or mitigated by adding or subtracting an adaptive offset (O) to a corresponding threshold value that decides on a redistribution (e.g., an outsourcing operation or a recovery) (or more generally by increasing or decreasing a corresponding range). By increasing the offset, the distance between the threshold value and the value for the current situation (being measured) can be enlarged so that, for example, in the case of small fluctuations in the value (such as network bandwidth), the threshold value is not reached. For a threshold value vector (i.e., a threshold value for multiple target variables such as bandwidth, latency, safety, etc.), an offset vector can be provided accordingly (wherein the components can be set individually).

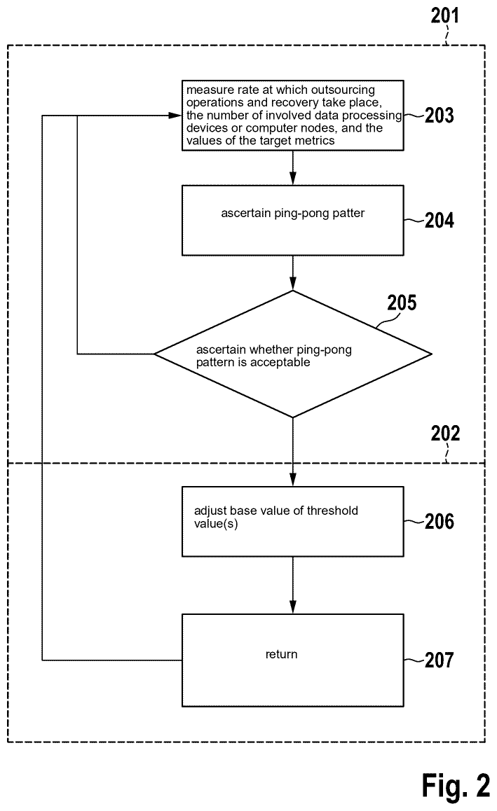

FIG. 2 illustrates a mechanism for detecting 201 and mitigating 202 jittery task distribution behavior, specifically ping-pong behavior in this example (i.e., outsourcing and recovery in rapid alternation).

The mechanism is implemented by a control device (which itself may be implemented as control software in the data processing system in a distributed manner).

Detecting 201 comprises detecting the ping-pong behavior and analyzing whether the behavior is acceptable. For this purpose, the rate (F) at which outsourcing operations and recovery take place, the number of involved data processing devices (N) or also compute nodes if a data processing device provisions multiple compute nodes, and the values of target metrics (C) for the outsourcing state and for the recovery state (e.g., performance characteristics achieved in these states, such as execution time, energy consumption, etc.) are measured in 203.

In 204, a ping-pong pattern is then ascertained on the basis of the measured rate (F). Such a pattern may, for example, include fast outsourcing operations and recovery occurring for 5 minutes every hour and, for example, rare outsourcing operations or recovery occurring for the remaining 55 minutes. The ping-pong pattern can be detected in various ways, in particular by statistical detection, which ascertains a probability distribution, machine learning models such as neural networks (in particular Bayesian networks), etc.

In 205, it is then ascertained whether the ping-pong pattern is acceptable (i.e., it is assessed). If it is acceptable, nothing is changed and the process returns to 203 (e.g., 203 to 205 are performed repeatedly, for example periodically).

Whether the ping-pong pattern is acceptable is ascertained by taking into account the number of involved data processing devices (N) and the values of the target metrics (C). For example, it may be acceptable if the behavior causes the values of the target metrics to be a certain percentage higher than if no outsourcing is allowed. In turn, it may, for example, not be acceptable if the outsourcing operation and recovery involve a large number of data processing devices. The ping-pong behavior can be regarded as incorrect behavior if the ping-pong pattern contains unnecessary outsourcing operations (which, for example, only bring a small increase in the values of the target metrics).

A ping-pong pattern is not acceptable if the rate of outsourcing operations and recoveries (i.e., reversals of the outsourcing operations) violates a permissibility criterion (which may depend on factors such as N and C or also on how long a particularly high rate occurs).

The ping-pong pattern can be assessed by comparing it to an undesirable ping-pong pattern.

If the ping-pong pattern is assessed as unacceptable, the ping-pong behavior is mitigated 202.

For this purpose, it is assumed that outsourcing takes place if the value of a target metric has reached or crossed (fallen below or exceeded) a threshold value C_{offload}, and that recovery takes place if the value of the target metric has reached or crossed a threshold value C_{recovery}. Reaching a threshold value can be regarded as crossing a threshold value that is close to it (below it when reached from below, above it when reached from above). Since a threshold value also defines a (valid) range (below the threshold value if a redistribution is triggered when the threshold value is exceeded, or above the threshold value if a redistribution is triggered when the threshold value is fallen below), the following also mentions that a redistribution is triggered or performed (i.e., takes place) if a corresponding range (assigned to the corresponding target metric) is left.

For the sake of simplicity, it is assumed here that only one target metric exists. However, multiple target metrics may also be provided and, accordingly, there is a vector of threshold values (one each for outsourcing and recovery). For example, outsourcing takes place as soon as a target metric has crossed a corresponding threshold value (i.e., a corresponding component of the threshold value vector) (in an upward direction, i.e., exceeds it, or in a downward direction, i.e., falls below it, depending on the type of threshold value).

In order to mitigate the ping-pong behavior, in 206, a base value C_{offload} Basis of the threshold value C_{offload} is adjusted by an offset O_{offload} and/or a base value of the threshold value C_{recovery_Basis} is adjusted by an offset threshold value O_{recovery}, resulting in the threshold value C_{offload} or the threshold value C_{recovery}.

If outsourcing takes place when C_{offload} is exceeded, a positive offset O_{offload} is, for example, added to the base value C_{offload_Basis} in order to mitigate the ping-pong behavior: C_{offload}=C_{offload_Basis}+O_{offload}, which delays (or even prevents) outsourcing.

Conversely, if outsourcing takes place when the threshold value is fallen below, a positive offset O_{offload} is deducted from the base value in order to mitigate the ping-pong behavior.

Analogously for the recovery: If recovery takes place when C_{recovery} is fallen below, a positive offset O_{recovery} is, for example, subtracted from the base value C_{recovery_Basis} in order to mitigate the ping-pong behavior: C_{recovery}=C_{recovery_Basis}−O_{recovery}, which delays (or even prevents) recovery. Conversely, if recovery takes place when the threshold value is exceeded, a positive offset O_{recovery} is added to the base value in order to mitigate the ping-pong behavior.

The offsets may, for example, be ascertained depending on the ascertained ping-pong pattern. They are increased if the ping-pong behavior gets worse or decreased if the ping-pong behavior decreases. For this purpose, the ping-pong pattern and, accordingly, the offsets are continuously updated, which is shown in FIG. 2 by the return from 207 to 203. Detecting 201 and mitigating 202 are thus continued (repeated) so that the data processing system 200 remains in a stable mode (except for acceptable ping-pong behavior).

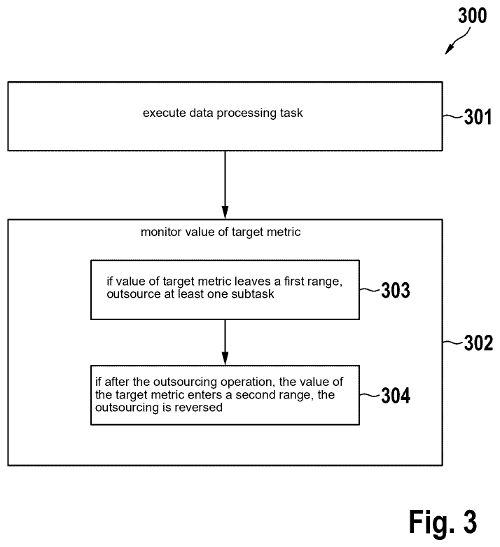

In summary, according to various embodiments, a method is provided as shown in FIG. 3.

FIG. 3 shows a flowchart 300 representing a method for executing data processing tasks by means of a data processing system according to an embodiment.

In 301, a data processing task is executed (or its execution is started) by means of a first group of data processing devices of the data processing system, wherein the first group contains at least one data processing device of the data processing system. In 302, when executing the data processing task, a value of a target metric for the execution of the data processing task is monitored.

If, in 303, the value of the target metric leaves a first range assigned to the target metric, at least one subtask of the data processing task (i.e., the execution of the subtask) is outsourced to a second group of data processing devices (wherein the second group differs from the first group, i.e., contains at least one data processing device that the first group does not contain and that is used to execute the subtask). In other words, the execution of the data processing task is continued, but the at least one subtask is executed by means of another data processing device.

If (after the outsourcing operation), in 304, the value of the target metric after the outsourcing operation enters a second range assigned to the target metric, the outsourcing operation of the at least one subtask (i.e., the outsourcing operation of the execution of the at least one subtask) is reversed.

If a rate of outsourcing operations and the reversal thereof violates a specified permissibility criterion, the first range assigned to the target metric is increased and/or the second range assigned to the target metric is decreased.

The method in FIG. 3 can be performed by one or more computers with one or more data processing units. The term “data processing unit” may be understood as any type of entity that enables processing of data or signals. The data or signals can be treated, for example, according to at least one (i.e. one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g. implemented) by a data processing unit by one or more special functions that are performed by the data processing unit.

The data processing task may be used to generate a control signal for a robotic device. The term “robotic device” may be understood to refer to any technical system (comprising a mechanical part whose movement is controlled), such as a computer-controlled machine, a vehicle, a household appliance, a power tool, a manufacturing machine, a personal assistant or an access control system. A control rule for the technical system is learned, and the technical system is then controlled accordingly.

The data processing task may include the processing of sensor data. This may include the processing of sensor signals from various sensors, such as video, radar, LiDAR, ultrasound, motion, thermal imaging, etc. The processing may, for example, comprise the classification of the sensor data or the execution of a semantic segmentation of the sensor data, for example in order to detect the presence of objects (in the environment in which the sensor data were obtained). Embodiments can be used to train a machine learning system and to control a robotic device, e.g., autonomously by robot manipulators, in order to achieve various manipulation tasks in different scenarios. In particular, embodiments are applicable to the control and monitoring of the performance of manipulation tasks, for example, in assembly lines.

Although specific embodiments have been depicted and described herein, a person skilled in the art will recognize that the specific embodiments shown and described may be replaced with a variety of alternative and/or equivalent implementations without departing from the scope of protection of the present invention. This application is intended to cover any adaptations or variations of the specific embodiments discussed herein.

1-10. (canceled)

11. A method for executing data processing tasks by a data processing system, the method comprising:
executing a data processing task using a first group of data processing devices of the data processing system, wherein the first group contains at least one data processing device of the data processing system;
monitoring, when executing the data processing task, a value of a target metric for the execution of the data processing task,
based on the value of the target metric leaving a first range assigned to the target metric, outsourcing the execution of at least one subtask of the data processing task to a second group of data processing devices; and
based on the value of the target metric after the outsourcing operation entering a second range assigned to the target metric, reversing the outsourcing operation of the execution of the at least one subtask;
wherein, based on a rate of outsourcing operations and the reversal of the outsourcing operatings violating a specified permissibility criterion, the first range assigned to the target metric is increased and/or the second range assigned to the target metric is decreased.

12. The method according to claim 11, wherein the permissibility criterion depends on a number of data processing devices of the first group and/or the second group that execute the data processing task.

13. The method according to claim 11, wherein a benefit of the outsourcing operations is ascertained and the permissibility criterion is specified depending on an ascertained benefit of the outsourcing operations.

14. The method according to claim 11, wherein, when the data processing task is executed using the first group of data processing devices, the data processing task is distributed according to a first division into subtasks to data processing devices of the first group, and, when the data processing task is outsourced, the data processing task is distributed according to a second division into subtasks to data processing devices of the first and the second group.

15. The method according to claim 11, wherein, when the rate of outsourcing operations and the reversal of the outsourcing fulfills the specified permissibility criterion and a relaxation criterion, the first range assigned to the target metric is decreased and/or the second range assigned to the target metric is increased.

16. The method according to claim 11, wherein the data processing task is the processing of sensor data to form control commands for a robotic device.

17. A control device configured to monitor execution of a data processing task, the data processing task being executed using a first group of data processing devices, wherein the first group contains at least one data processing device of a first data processing system, based on the value of the target metric leaving a first range assigned to the target metric, the execution of at least one subtask of the data processing task being outsourced to a second group of data processing devices, and based on the value of the target metric after the outsourcing operation entering a second range assigned to the target metric, the outsourcing operation of the execution of the at least one subtask being reversed, wherein the control device is configured to, based on a rate of outsourcing operations and the reversal of the outsourcing operatings violating a specified permissibility criterion, increase the first range assigned to the target metric is increased and/or decrease the second range assigned to the target metric, and wherein the control device is configured to request the data processing system to request the data processing system execute the data processing task according to the first range assigned to the target metric and according to the second range assigned to the target metric.

18. A data processing system configured to execute data processing tasks by a data processing system, the data processing system configured to:
execute a data processing task using a first group of data processing devices of the data processing system, wherein the first group contains at least one data processing device of the data processing system;
monitor, when executing the data processing task, a value of a target metric for the execution of the data processing task,
based on the value of the target metric leaving a first range assigned to the target metric, outsource the execution of at least one subtask of the data processing task to a second group of data processing devices; and
based on the value of the target metric after the outsourcing operation entering a second range assigned to the target metric, reverse the outsourcing operation of the execution of the at least one subtask;
wherein, based on a rate of outsourcing operations and the reversal of the outsourcing operatings violating a specified permissibility criterion, the first range assigned to the target metric is increased and/or the second range assigned to the target metric is decreased.

19. A non-transitory computer-readable medium on which are stored commands for executing data processing tasks by a data processing system, the commands, when executed by a processor, causing the processor to perform:
executing a data processing task using a first group of data processing devices of the data processing system, wherein the first group contains at least one data processing device of the data processing system;
monitoring, when executing the data processing task, a value of a target metric for the execution of the data processing task,
based on the value of the target metric leaving a first range assigned to the target metric, outsourcing the execution of at least one subtask of the data processing task to a second group of data processing devices; and
based on the value of the target metric after the outsourcing operation entering a second range assigned to the target metric, reversing the outsourcing operation of the execution of the at least one subtask;
wherein, based on a rate of outsourcing operations and the reversal of the outsourcing operatings violating a specified permissibility criterion, the first range assigned to the target metric is increased and/or the second range assigned to the target metric is decreased.
